(19) United States
(12) Patent Application Publication
(10) Pub. No.: US 2006/0075963 A1
(43) Pub. Date: Apr. 13, 2006

(54) Vacuum rotational seeding and loading device and method for same

(76) Inventors: Alejandro Nieponice, Pittsburgh, PA (US); David A. Vorp, Pittsburgh, PA (US); Lorenzo Soletti, Pittsburgh, PA (US)

Correspondence Address: BAKER & BOTTS, 30 ROCKEFELLER PLAZA, NEW YORK, NY, 10112, US

(21) Appl. No.: 11/243,818

(22) Filed: Oct. 5, 2005

Related U.S. Application Data
(60) Provisional application No. 60/616,057, filed on Oct. 5, 2004.
(60) Provisional application No. 60/649,255, filed on Feb. 2, 2005.

(51) Int. Cl. B05C 3/00; B05D 3/00

(52) U.S. Cl. 118/417; 427/2.14

(57) ABSTRACT

An apparatus for seeding material in a scaffold member capable of entrapping such seeding material therein is provided. The apparatus may include a chamber having an interior and capable of maintaining a negative pressure and capable of enclosing the scaffold member therein, and a support member for rotating the scaffold member disposed within the interior of the chamber and for introducing the seeding material into the chamber. At least a portion of rotating the scaffold member occurs simultaneously with applying the negative pressure condition to the scaffold member. The seeding material may be passed from the interior of the scaffold member to the exterior of the scaffold member in response to the application of negative pressure such that at least of portion of the seeding material is entrapped in the scaffold member.

### CLAIM FOR PRIORITY TO RELATED APPLICATIONS

This application claims the benefit of U.S. Provisional Patent Application Ser. No. 60/616,057, filed on Oct. 5, 2004, entitled “Vacuum Rotational Seeding and Loading Device and Method for Same,” and U.S. Provisional Patent Application Ser. No. 60/649,255, filed on Feb. 2, 2005, entitled “Vacuum Rotational Seeding and Loading Device and Method for Same,” both of which are hereby incorporated by reference in their entirety herein.

### STATEMENT OF GOVERNMENT RIGHT

The work leading to this invention was supported in part by the U.S. Government under NIH Grant R10 HL069368-01A1. The U.S. Government has certain rights in the invention.

### BACKGROUND

1. Field of the Invention

The present invention relates generally to seeding and loading devices and methods, and particularly to vacuum seeding and loading devices and methods for vacuum seeding using such devices.

2. Background of the Related Art

A very high demand exists for tissue and organ donations among patients affected by degenerative diseases or traumatic injuries. For example, in 2003 over 86,000 people were on waiting lists to receive tissue and organ transplantation in the United States, compared with 13,000 actual donors. (Organ Procurement and Transplantation Network. OPTN/SRTR Annual Report, 2004.) This discrepancy between recipients and donors over the years has stimulated the evolution of new disciplines such as regenerative medicine. The field of regenerative medicine offers hope to these patients by drawing upon advances in stem cell biology, developmental biology, and tissue engineering to provide tissue substitutes to the enormous number of patients in need of such tissues or organs. Tissue engineering has brought together scaffold structures and cells to create functional tissues.

Cell seeding constitutes a critical step in those tissue engineering approaches that incorporate cells into or onto scaffolds prior to culture or implantation. Surface seeding typically refers to lining cells on a luminal surface. Bulk seeding typically refers to the delivery of cells throughout the depth or thickness of the scaffold. Most of the current seeding techniques involve the use of a device to seed cells on surfaces. These devices take advantage of different driving forces such as sedimentation, rotation, electric field, or vacuum. The use of a seeding device may be challenging since mechanical forces are often involved in seeding procedures and can be responsible for force-mediated membrane lysis or triggering of apoptotic pathways.

Bulk seeding is typically a more difficult task to accomplish especially in a controllable manner. The complex micro-architectures of the scaffolds often hamper the passive incorporation of cells throughout the thickness of the material. Dripping cell suspension on the matrix for impregnating the scaffold is a typical technique for bulk incorporation of cells into scaffolds. This technique is not intrinsically able to warrant a high level of quality control on the final engineered tissue due to the manual nature of the procedure.

In addition to the limitations of known techniques, such as cell injury and non-uniform cell distribution, it typically requires a long culture duration (several weeks) to achieve full-thickness cellular content. Accordingly, a need exists for a seeding technique that would minimize cell injury, and provide uniform cell distribution, high seeding efficiency, reduced seeding time, reproducibility, and user independence.

### SUMMARY OF THE PRESENT INVENTION

It is an object of the current invention is to overcome the aforementioned limitations to the state of the art seeding techniques.

It is another object of the current invention to provide a cell or particle seeding technique and apparatus for use with tubular scaffolds or synthetic tubular grafts.

In accordance with one embodiment of the present invention, an apparatus is provided for seeding material in a scaffold member capable of entrapping such seeding material therein. The apparatus may include a chamber having an interior and capable of maintaining a negative pressure environment and capable of enclosing a scaffold member therein, and a support member for rotating the scaffold member disposed within the interior of the chamber and for introducing the seeding material into the chamber. In some embodiments, an external infusion pump is provided to control internal delivery of a cell or particle suspension.

In some embodiments, the support member comprises a hollow shaft. The scaffold member may define an interior portion in communication with the interior portion of the support member, such that the seeding material is introduced into the interior of the scaffold member via the support member.

A method of the seeding material in a scaffold structure is also provided, which includes applying a negative pressure condition to a scaffold member positioned within a chamber, introducing seeding material in the scaffold member, and rotating the scaffold member, wherein at least a portion of rotating the scaffold member occurs simultaneously with the application of the negative pressure condition.

In some embodiments, the scaffold member has a tubular structure defining an interior, such that the seeding material is introduced into the interior of the scaffold member. The seeding material may be passed from the interior of the scaffold member to the exterior of the scaffold member in response to the application of negative pressure and a controlled infused flow such that at least of portion of the seeding material is entrapped in the scaffold member. In some embodiments, entrapping the seeding material includes entrapping the seeding material adjacent the interior surface of the scaffold member. In some embodiments, entrapping the seeding material includes entrapping the seeding material throughout the thickness of the scaffold member.

The contemporaneous application of a negative pressure condition, controlled infusion, and rotation of the scaffolding provides at least the following noteworthy advantages. First, it permits vacuum seeding for a tubular structure. Vacuum seeding as opposed to culture seeding is beneficial in terms of time and efficiency. This also permits bulk seeding as opposed to only surface seeding which provides for more rapid and spatially uniform distribution of cells. Second, it allows for synergistic rotation throughout the seeding to negate gravitational effects. Thus the end product is more likely to have an even distribution as opposed to an unbalanced distribution. Third, it permits the varying of vacuum strength and rotation speed. This may allow, after seeding, for dynamic culture options in the same chamber and can obviate the need for transferring the construct to a different bioreactor. Fourth, it allows the use of vacuum and centrifugal effect as driving forces for cell convection.

One aspect of the present invention may have particular relevance to bulk seeding, as it can allow the construct to be seeded in minutes with the desired amount of cells needing only the culture time that each cell type requires to adapt to the scaffold.

Another aspect of the present invention may also have particular relevance to surface seeding (e.g., endothelialization), as it can allow surface seeding of the luminal side of any tubular structure. For example, existing synthetic vascular grafts that can benefit from endothelialization to increase patency rates can be seeded with this device in a cost-effective manner.

Another aspect of the present invention may also have particular relevance to scaffold coating or loading with growth factors, drugs, microspheres, etc. Depending on the composition of each tubular scaffold, some may need further coatings with biological compounds to provide cells a more amenable environment to grow (e.g., fibronectin). Moreover, the biological action of the cells on the scaffold can sometimes be further stimulated with a variety of growth factors loaded in the polymer. This vacuum chamber allows any particulate (e.g., micro spheres) to be loaded into or coated onto tubular structures.

Another aspect of the present invention may also have particular relevance to rotating culture for tubular scaffolds, or tubular constructs. Tissue engineered tubular grafts (TETGs) often require dynamic culture to allow even distribution of nutrients to mural cells during development, especially when the thickness of the scaffold is enough to alter the diffusion of nutrients. Though different devices exist to perform this kind of culture, this chamber offers an alternative approach with its rotating capability. The TETG can be immersed in a bath of media with an equivalent perfusate while being rotated at the desired speed.

### BRIEF DESCRIPTION OF THE DRAWINGS

For a more complete understanding of the present invention, and the advantages thereof, reference may be made to the following written description of exemplary embodiments, taken in conjunction with the accompanying drawings.

FIG. 1 is a schematic of the interacting components of a seeding device in accordance with an exemplary embodiment of the present invention.

FIG. 2 is a perspective view of a portion of the seeding device of FIG. 1 in accordance with an exemplary embodiment of the present invention.

FIG. 3 is a perspective view of a portion of the seeding device of FIG. 1 in accordance with an exemplary embodiment of the present invention.

FIG. 4(a) is a schematic depiction of the introduction of the seeding material in the scaffold device in accordance with an exemplary embodiment of the present invention.

FIG. 4(b) is a schematic depiction of the seeded scaffold device in accordance with an exemplary embodiment of the present invention.

FIG. 5 is perspective view of a cartridge suitable for use in a chamber of a seeding device in accordance with another exemplary embodiment of the present invention.

FIG. 6(a) is perspective view of a cartridge suitable for use in a chamber of a seeding device in accordance with a further exemplary embodiment of the present invention.

FIG. 6(b) is perspective view in partial section of a cartridge illustrated in FIG. 6(a) in accordance with a further exemplary embodiment of the present invention.

FIG. 7 is a sectional view illustrating the nuclei distribution of a vacuum seeded tube in accordance with an exemplary embodiment of the present invention.

FIG. 8 is a sectional view illustrating the nuclei distribution of a native rat aorta.

FIG. 9 is a sectional view illustrating the cell distribution of a vacuum seeded tube in accordance with an exemplary embodiment of the present invention.

FIG. 10 is a graph illustrating the cell distribution (averages and standard deviations) of the percentages of cells present in longitudinal segments of seeded scaffolds in accordance with an exemplary embodiment of the present invention.

FIG. 11 is a graph illustrating the cell distribution (averages and standard deviations) of the percentages of cells present in circumferential segments of seeded scaffolds in accordance with an exemplary embodiment of the present invention.

FIG. 12 is a schematic depiction of a seeded scaffold in accordance with an exemplary embodiment of the present invention.

FIGS. 12(a)-12(i) are sectional views taken along lines 12a-12i, respectively, of the seeded scaffold of FIG. 12 in accordance with an exemplary embodiment of the present invention

FIG. 13 is a sectional view of a surface seeded scaffold in accordance with an the present invention.

FIGS. 14(a)-(b) illustrate sectional views by scanning electron microscopy (SEM) of an unseeded control polymer.

FIGS. 15(a)-(b) illustrate sectional views by SEM of a surface seeded scaffold after 12 hours of culture in accordance with an exemplary embodiment of the present invention.

FIGS. 16(a)-(b) illustrate sectional views by SEM of another surface seeded scaffold after 12 hours of culture in accordance with an exemplary embodiment of the present invention.

Throughout the figures, the same reference numerals and characters, unless otherwise stated, are used to denote like features, elements, components or portions of the illustrated embodiments. Moreover, while the present invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF THE INVENTION

This invention will be further understood in view of the following detailed description of exemplary embodiments.

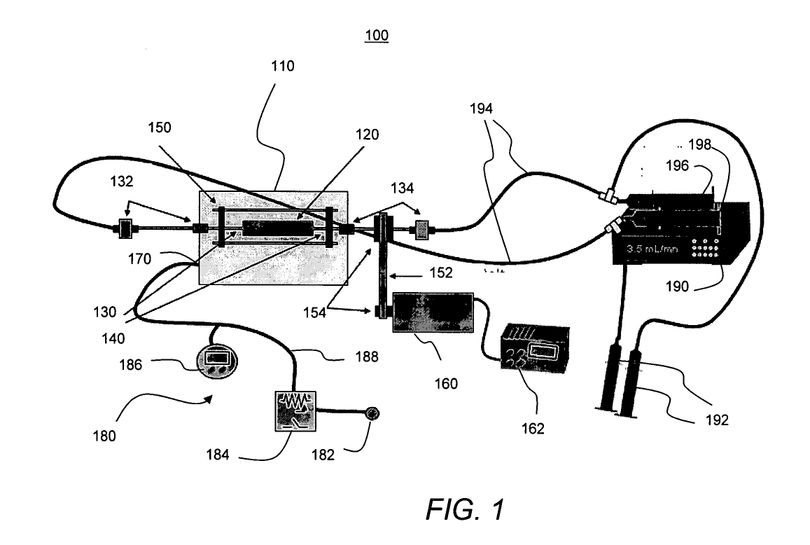

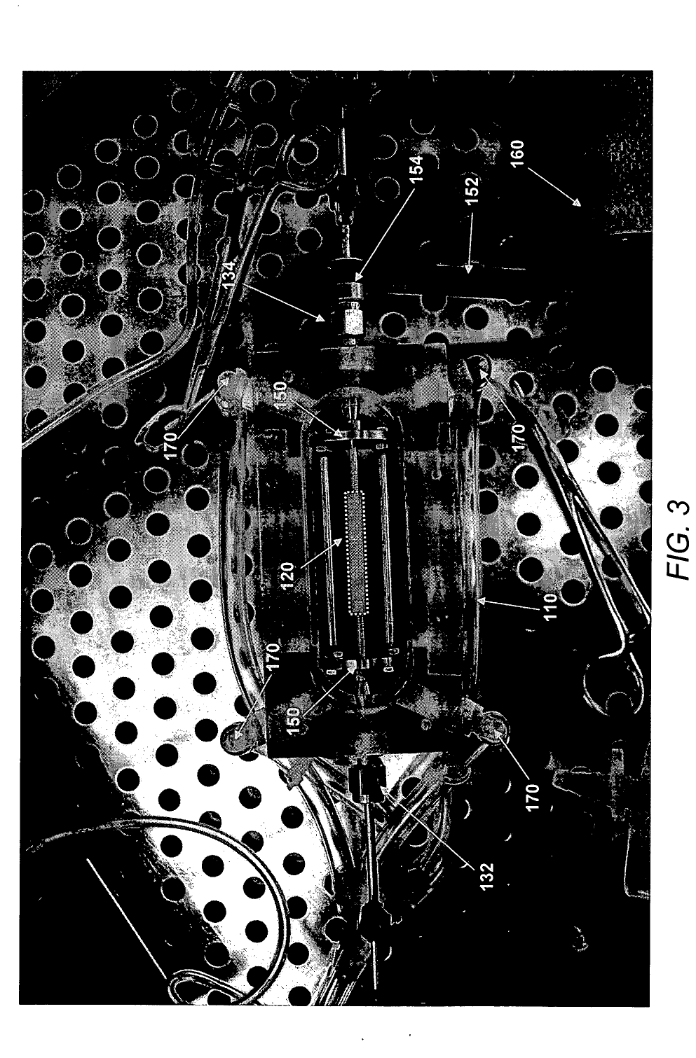

FIGS. 1-3 depict a seeding device according to an exemplary embodiment of the present invention. The device 100 may include a chamber 110 capable of maintaining a reduced pressure environment, e.g., a “vacuum.” In an exemplary embodiment, chamber 110 is airtight and machined from a solid block of acrylic. The chamber 110 may be capable of holding a porous tubular structure to be seeded, such as scaffold 120, by use of two support tubes, such as tees 130, 140, which may be coaxially mounted in the chamber 110 and spaced apart according to the dimensions of the scaffold 120. In the exemplary embodiments, scaffolds 120 are mounted onto the tees 130, 140 via two tygon tubing tips secured with 2-0 silk sutures. It is understood that other means of attachment of the scaffolds 120 to the tees 130, 140 may be employed, e.g., clamps, wires, adhesives, connectors, etc. In the exemplary embodiment, tees 130, 140 are fabricated from stainless steel and have an outer diameter of about 3 mm, an inner diameter of about 2 mm, and a length of about 20 cm. Two pneumatically sealed rotating joints 132, 134 allow for the rotation of the tees 130, 140 through the wall of the chamber 110 without pressure loss.

In the exemplary embodiment, the tees 130, 140 are coaxially mounted in the chamber 110 with a torque transmission device 150, such as a concentric assembly of rods, which transmits rotation from one tee to the other, allowing the tees to rotate in a synchronized fashion. The torque may be applied to one of the tees through a belt driven mechanism including, e.g., a timing belt 152 and pulleys 154, and powered by an electrical motor 160. Console 162 includes a level control to allow the user to control the speed of rotation of the tees 130, 140. The rotation speed range useful for effective seeding is about 60 rpm to about 1000 rpm, although it is understood that other speeds are useful for the seeding process. Thus, the rotation of the scaffolds 120 may occur by the mechanical attachment of the scaffolds 120 to the rotating tees 130, 140, as described herein above.

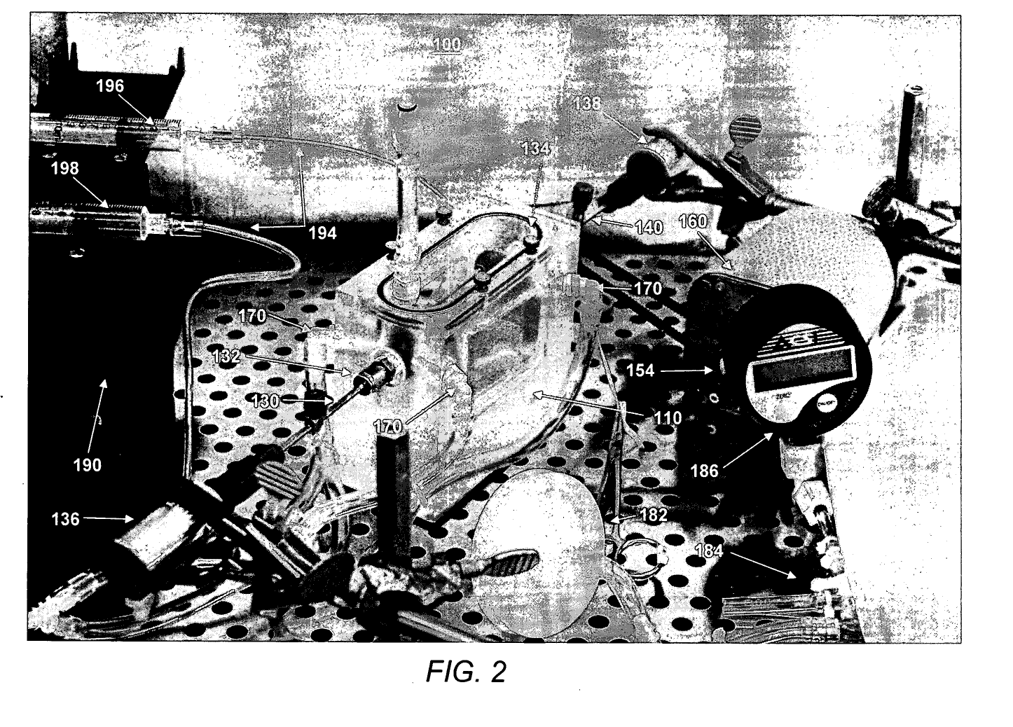

A negative pressure (e.g., less than atmospheric pressure) environment may be applied within the chamber 110 by way of one or more evenly distributed ports or nozzles 170. The pressure may be in the range of about −20 to −300 mm Hg. In an exemplary embodiment, four nozzles are used. The nozzles 170 inside the chamber 110 are connected to a vacuum circuit, such as pneumatic resistive circuit 180, which in turn is connected to a vacuum port 182. The pneumatic resistive circuit 180 is capable of maintaining a constant and controllable negative relative pressure inside the chamber 110 throughout the seeding process using a flow regulator 184 and a vacuum gauge, such as digital vacuum gauge 186 (An exemplary digital vacuum gauge is manufactured by ACSI, Irvine, Calif.). The nozzles 170 inside the chamber 110 may be connected to the lab vacuum line 188 by a 0.2 μm PTFE air filter 182 (An exemplary air filter is manufactured by Acro® 50, Pall Corporation, East Hills, N.Y.) illustrated in FIG. 2, placed in parallel to the air circuit 180. The air circuit 180 may be kept sterile using the air filter which also may provide external resistance required to achieve the necessary flow.

The tees 130, 140 are each connected to a precision syringe pump 190 (An exemplary syringe pump is manufactured by Harvard Apparatus Inc., Holliston, Mass.) outside the chamber 110, by tubing, such as polyvinyl chloride (PVC) tubing 194. As illustrated in FIG. 2, the tubes are connected to the tees 130, 140 by means of rotating joints 136, 138 that allow for the passage of the seeding suspension material from the tubing 194 to the tees 130, 140 while the tubing is in rotation. Syringe pump 190 has a flow control for modulating the flow rate of the seeding material into the scaffold member 120.

Scaffolds 120 may be manufactured from any type of porous tubular material. In an exemplary embodiment, for example, poly(ester urethane)urea (PEUU) may be used. According to one exemplary embodiment, scaffold 120 has a porosity of about 90% and a pore size range of about 10-200 μm, and may be prepared by thermally induced phase separation (TIPS) to a length of 2 cm, inner diameter 3.3 mm, and thickness 200-300 μm. (A TIPS technique is described in Guan J, Fujimoto K L, Sacks M S, and Wagner W R, “Preparation and characterization of highly porous, biodegradable polyurethane scaffolds for soft tissue applications,” Biomaterials 2005;26(18):3961-71, which is incorporated by reference in its entirety herein.) According to another exemplary embodiment, scaffold 120 has a porosity of about 90% and a pore size of about 10 μm, and may be fabricated by electrospinning PEUU onto a rotating 3.5 mm stainless steel mandrel to a length of 2 cm, and a thickness of 200 μm. (A useful technique for fabricating the scaffold is described in Stankus J J G J, and Wagner W R, “Fabrication of Biodegradable, Elastomeric Scaffolds with Sub-Micron Morphologies,” In press 2004, which is incorporated by reference in its entirety herein.)

The loading process may be achieved with two axially coupled loading syringes 196, 198 attached on each end of the tees 130, 140 through a standard Luer® connection. Once the reduced pressure condition is applied inside the chamber 110, the plungers of loading syringes 196, 198 may be drawn by the infusion vacuum force with a flow rate proportional to the driving force. The tubing is connected through Luer® connectors. The seeding process may be performed within about 20 seconds to about 5 minutes depending on the volume of the seeding suspension, and the physical characteristics of the scaffold 120. Priming and flushing syringes 192 may also be provided. The plungers of loading syringes 196, 198 may also be used to modulate the flow rate of the seeding material into the scaffold member 120.

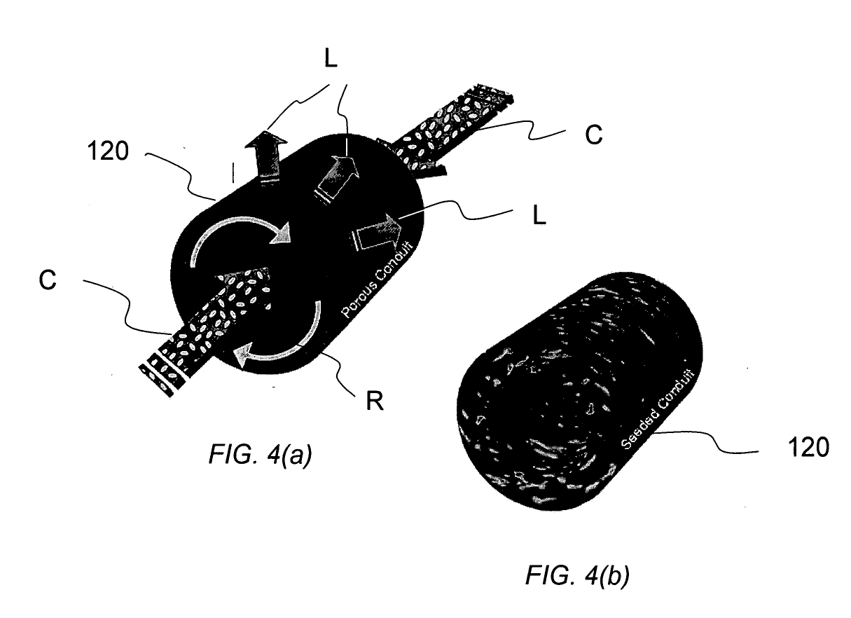

The seeding device 100 utilizes the synergistic actions of reduced pressure applied inside the chamber 110 and the flow generated by the syringe pump 190 to induce a transmural flow through the polymer material of the scaffold 120. The interior portion of the scaffold member 120 is in communication with the interior portion of the tees 130, 140. The infused flow, e.g., cell material suspended in a medium, passes through the interior of the tees 130, 140 to the scaffold 120. FIG. 4(a) illustrates the infused flow entering the interior of the scaffold 120 as indicated by arrows C. During this phase, the particulate (e.g., cells, microspheres) infused by the syringe 196, 198 become entrapped within the pores of the polymer material of the scaffold 120 while the liquid phase of the cell suspension exudes through (as indicated by arrow L). The tubular scaffold 120 rotates during the seeding (as indicated by arrow R) in order to increase the uniformity of seeding along its circumferential direction. FIG. 4(b) illustrates a seeded scaffold 120. It is understood that the application of negative pressure, the infusion of the seeding suspension, and the rotation of the scaffold occur independently. However, the application the negative pressure and the rotation of the scaffold occur simultaneously for at least a portion of the process described herein.

The particulate material which is intended to be entrapped in the scaffold is generally referred to herein as the seeding material, which may include any appropriate cell material suspended in a medium. According to an exemplary embodiment, murine muscle-derived stem cells (MDSC) obtained from an established pre-plating technique may be cultured and seeded in Dulbecco Modified Eagle Medium (DMEM) (Sigma) supplemented with 1% Penicillin/Streptomycin (Gibco, Invitrogen Corporation, Carlsbad, Calif.), 10% Fetal Calf Serum (Atlanta Biologicals, Norcross, Ga.), and 10% Horse Serum (Gibco, Invitrogen Corporation). (A pre-plating technique is described in Qu-Petersen, Z., et al., “Identification of a novel population of muscle stem cells in mice: potential for muscle regeneration,” The Journal of Cell Biology, 2002. 157(5): p. 851-64, which is incorporated by reference in its entirety herein.) In another exemplary embodiment, isolated rat bone marrow derived progenitor cells (rBMPC) may be cultured and seeded in DMEM (Sigma) supplemented with 10% bovine serum (Gibco, Invitrogen Corporation) and 1% Penicillin/ Streptomycin (Gibco, Invitrogen Corporation). (A technique for isolating the bone marrow is described in Dexter, T. M. and L. G. Lajtha, “Proliferation of haemopoietic stem cells in vitro,” British Journal of Haematology, 1974. 28(4): p. 525-30, which is incorporated by reference in its entirety herein.) In a further exemplary embodiment, bovine aortic endothelial cells (bAEC) (Cambrex Corporation, East Rutherford, N.J.) were cultured and seeded in EGM-MV media (Cambrex). The seeding material may include any cell type, microspheres, microparticles, liposomes, adhesion proteins, growth factors, or drugs.

The device 100 may allow effective seeding without generating injurious mechanical conditions for the cells by maintaining low shear stresses acting on the cells during seeding. A calculation of the shear stresses was performed by use of the computational fluid dynamic (CFD) software Fluent (version 6.2, Fluent Inc., Lebanon N.H.). For this purpose, a 4.5·10⁵ wedges volume mesh was created (Gambit 2.2, Fluent Inc., Lebanon, N.H.) with boundary layers on the luminal surface of the model. The model consisted of a composite tube modelled as porous media in the larger central portion corresponding to the scaffold 120 and as rigid tubes in the two peripheral portions corresponding to the tees 130, 140. The permeability of the polymer was calculated empirically via Darcy law by measuring the pressure loss (e.g., model TJE, Honeywell Sensotec, Columbus, Ohio) per unit surface area of the polymer for a measured exudation rate of saline. The density of the fluid was proportionally calculated for a 10% serum (1025 kg/m³) solution in culture media (1008 kg/m³) and determined to be 1010 kg/m³. The dynamic viscosity of the cell suspension was measured with a capillary viscometer (e.g., Cannon-Manning, Cannon Instruments Company, State College, Pa.), and a rheologic curve was generated with a digital cone and plate rheometer (e.g., DV-III, Brookfield Engineering Labs, Middleboro, Mass.) in order to demonstrate the Newtonian properties of the fluid under shear rate ranges obtained with the device.

The CFD simulation was performed in steady state. The solver was segregated with implicit formulation and SIMPLE pressure-velocity coupling. A spatially uniform velocity was assigned to the two inlets with 10 diameters of flow extension to allow for flow profile development. The rotation of the tees 130, 140 was simulated as a moving mesh. Convergence was taken as residual values≦10⁴ and confirmed with stability of two surface monitors (average absolute pressure on outlet surface and average velocity on an interior surface). The outlet was modelled with a constant pressure equal to the vacuum pressure inside the chamber 110. The wall shear stress (WSS) on the luminal surface of the model was determined by the software while the WSS acting on the scaffold pores was estimated analytically. In brief, the conservation of momentum in laminar flow conditions was considered for cylindrical pore and modified with the Hagen-Poiseuille equation for the pressure drop, as further described in R Byron Bird WES and Edwin N. Lightfoot, Transport Phenomena, (2nd ed: John Wiley & Sons, Inc.; 2002). The average velocity in the pore was set by considering the measured total flow rate entering the scaffold divided by the effective open area of the luminal surface of the scaffold (effective open area=porosity·internal luminal cylindrical area) with the assumption of even distribution of the inlet flow rate in the porous luminal surface of the scaffold. The resulting equation for wall shear stress is

$${τ}_{rz , max} = \frac{{\overline{v}}_{z} \cdot 4 \cdot μ \cdot }{R} \qquad [ 1 ]$$

where \overline{ν}_{z} is the average velocity in the pore, μ the dynamic viscosity, and R the radius. The radius used in the equation was 10 μm consistent with the smallest pores of the porous polymer.

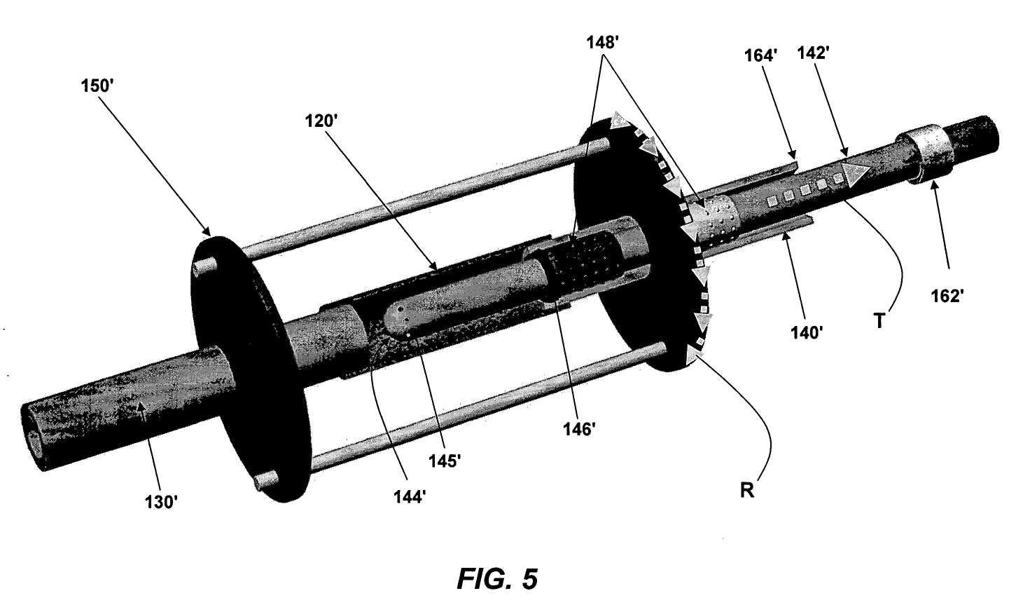

FIG. 5 illustrates a further embodiment of a cell delivery mechanism 100′ suitable for use in the chamber 110 for seeding longer scaffolds (>5 cm). Cell delivery mechanism is substantially identical to the mechanism described hereinabove, with the differences noted below. For example, the internal structure of tee 140′ may be modified. A smaller coaxial internal tee 142′ may be inserted into the tee 140′. The internal tee 142′ may terminate with a head 144′ radially drilled with a number of apertures, e.g., nozzles 145′. The coaxial tees 142′ is free to move within the interior of the scaffold 120′. In particular, coaxial tee 142′ may move axially with respect to the tee 140′ (as indicated by arrow T) with substantially reduced friction due to the presence of the linear bearings 148′. The support member 162′ may connect the internal tee 142′ to a motor driven linear positioner controlled by a console (not shown) that moves the tee 142′ along the axial direction (as indicated by arrow T) without allowing rotation of the tee 142′. The linear bearings 148′ may allow for the rotation of the tee 140′ around the tee 142′. While the tee 140′ is put in rotation by the motor 160 (as indicated by arrow R), the tee 142′ may slide axially inside, driven by the linear positioner. In proximity of the scaffold 120′, the two coaxial tees 140′, 142′ may be sealed by a teflon seal 146′ that avoids pressure losses and seeding suspension spillings between the two coaxial tees 140′, 142′ during mutual movements. The tee 140′ may cross the wall of the chamber 110 by means of the sealed joint 134 (not shown in FIG. 5). Externally to the chamber 110 in proximity of the joint 134, the tee 140′ may be connected to the pulley 154, and moved with the timing belt 152 by the motor 160. The tee 140′ ends externally to the pulley 154. The internal tee 142′ may be connected by tubing 194 to the syringe 196. The head 144′ may be initially positioned to the level corresponding to an end of the scaffold 120, in proximity with the opposite tee 130′. The tees 130′, 140′ may be put in rotation, the vacuum applied into the chamber, and the infusion pump 190 started to release the seeding suspension though the nozzles 145′ of the head 144′. The seeding suspension begin to exude through the scaffold 120′ in proximity to the current level of the head 144.′ The head 144′ may be moved along the length of the scaffold (for example, in the direction of arrow T), with a velocity, for example, ranging from about 0.015 to about 0.15 cm/sec by means of the motor driven linear positioner. The exudation of seeding suspension moves accordingly with the internal tee 142′, allowing for a uniform sseding along the length of the scaffold 120′.

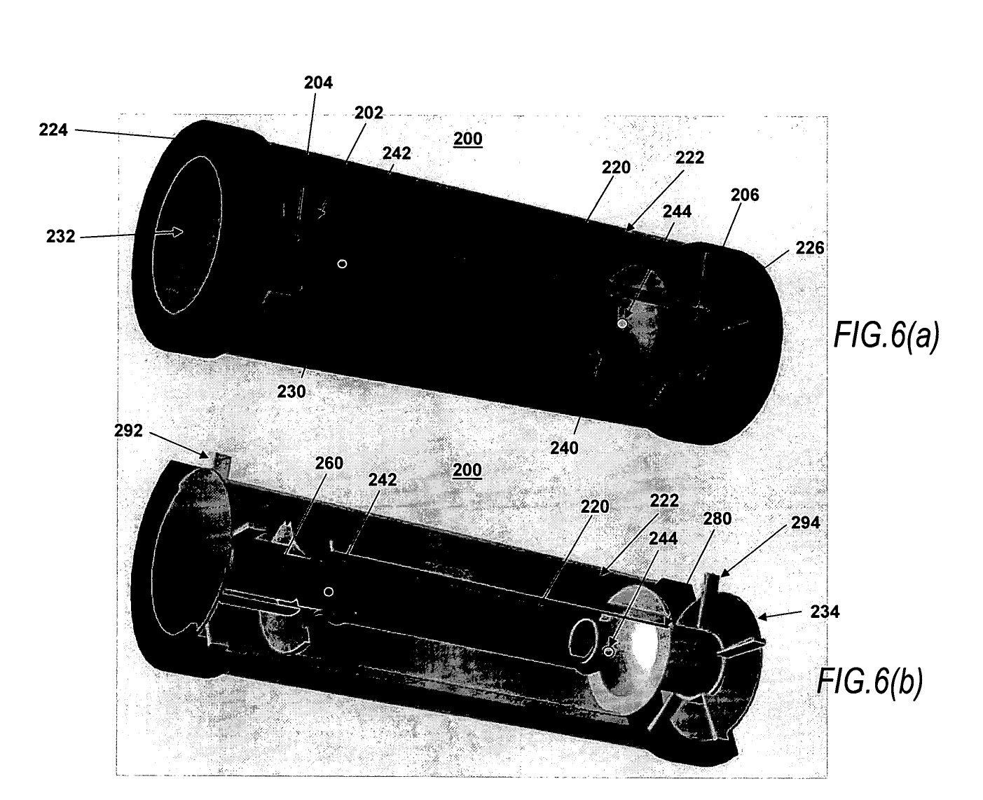

FIGS. 6(a)-6(b) depict a disposable sterile cartridge 200 suitable for use in the chamber 10 of a seeding device according to another exemplary embodiment of the present invention. In contrast to the device illustrated in FIGS. 1-3, scaffold 120′ is rotated by a magnetic attachment to the support members, e.g., tees 130′, 140′. Cartridge 200 includes a porous scaffold 220, which is substantially as described above regarding scaffold 120, mounted on a removable cylindrical rotating internal main body 202. The main body 202 may be composed of two peripheral cylindrical hollow spaces 204, 206, a built in torque transmission 280, and two tees 230, 240. The hollow spaces 204, 206 bear inside two collapsible bags made of PVC 260 (one shown in FIG. 6(b) and another collapsible bags is positioned adjacent the other end portion of the device) having a paraboloidal shape. The open circular edges of the collapsible bags are internally sealed with the tees 230, 240 in proximity to the point where the scaffold 220 is mounted. The external walls of these two hollow spaces hold a disk of magnetic material used for communication of an external torque (not visible in the figures). A transparent polycarbonate tube, threaded at its ends, forms the external surface of the disposable cartridge 222. Two caps 224, 226 each include a 0.22 μm PTFE filter 232, 234 that communicates the negative pressure from the chamber 110 to the interior of the cartridge 200, maintaining the sterility into the cartridge, and a rotational support structure 292, 294 that allow, when the cartridge is mounted, the rotation of the internal body 202 in respect to the external sheath 222 and the two caps 224, 226. The rotating body is removed from the sheath 222 by unscrewing one cap 224. The cell suspension is introduced with a syringe into the interior of the rotating body 202, which include the internal spaces of the collapsible bags 260, and the internal space of the scaffold 220, by means of the priming port 242 and the venting port 244 that allows for removal of air while filling with cell suspension. The loaded main body 202 is repositioned into the sheath 222 and the cap 224 repositioned as well. The main body 202 is put in rotation with external rotating magnets present in the chamber 110 that communicate the torque by means of the magnetic disks attached to the body 202. The vacuum inside the modified chamber 110 is applied and communicated to the interior of the cartridge by means of the filters 232, 234. The transmural flow generated by the application of an external vacuum into the modified chamber 110 allows the liquid material to exude through the scaffold 220. During the exudation of the liquid phase of the cell suspension through the scaffold, the collapsible bags 260 retract into the scaffold until they touch each other in the center of the scaffold completing the seeding procedure.

### EXAMPLES

Bulk Seeding Experiments

Qualitative evaluation of the seeding was performed by seeding two 2 cm TIPS tubular scaffolds with 10.106 BMPC suspended in 10 mL of culture media (flow rate=3.4 mL/min, rotation speed=120 rpm, vacuum=−127 mmHg). Nuclear and cytoskeletal stains were visualized by epifluorescent microscopy of cross sections taken after two hours of static culture. Quantitative evaluation was performed by calculating the seeding efficiency of seeded scaffolds and also via two specifically designed experiments. The seeding efficiency (percent of the total number of cells incorporated) was calculated by determining the cell count in the seeding solution before and after seeding using a hemocytometer.

The first designated experiment for quantitative evaluation of the seeding performances involved six 2 cm long TIPS tubular scaffolds seeded with 15·10⁶ MDSC. The cells were suspended in 20 mL of culture media and infused to the scaffold under identical conditions (flow rate=8 mL/min, rotation speed=350 rpm, vacuum=−127 mmHg, duration of seeding=1 minute). After seeding, each construct was kept for two hours in static culture and subsequently cut into nine serial equi-sized rings. Each ring underwent metabolic-based cell count (MTT) in order to detect the cell number in each ring and therefore in each longitudinal location for seeded construct. Comparisons of the average and standard deviation of the measures allowed assessment of the reproducibility of the longitudinal distribution of cells in the constructs seeded with the device.

The second experiment was designed to assess the cell distribution along the circumferential direction. For this, a 2 cm long construct was seeded, cultured, and cut using the same conditions, parameters, and cells as the first experiment. However, the construct was cut along the longitudinal direction to keep track of the relative circumferential position among different sections. For each of the nine longitudinal segments, three 15 μm-thick sections were cut and stained with nuclear stain. Each stained section was digitally photographed reconstructing from 16 serial fields of view at 200× magnification. Subsequently, each reconstructed section image was cropped in four cardinal sectors according to the curve-abscissa on the centreline of the section. Each cardinal sector of each section underwent image-based quantification of the cell number with an intensity threshold filter (Scion Image 4.0, Scion Corporation). The cell number in each sector was measured dividing the total area occupied by the nuclei divided by the average area occupied by one nucleus.

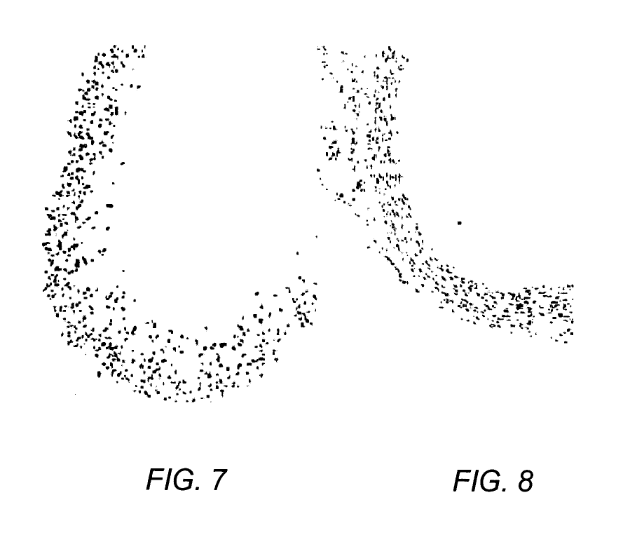

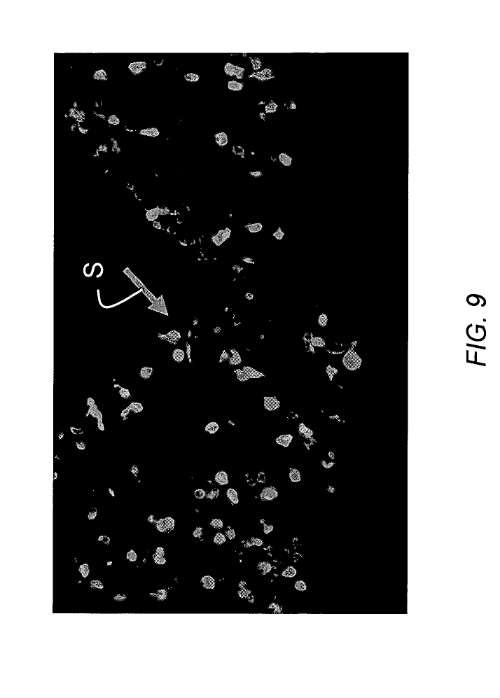

For a qualitative assessment, a representative seeded section (FIG. 7) was compared with a native rat aorta treated with the same nuclear stain (FIG. 8). The native vessel and seeded construct had similar cell distribution throughout the thickness of the polymer within minutes of seeding procedure. As illustrated in FIG. 9, the cells incorporated into the constructs maintained the spheroidal shape two hours after seeding as evidenced by F-actin stain. Arrow S indicates the luminal surface of the scaffold. (200× magnification) The cells started to spread in the pores after 1 day (data not shown).

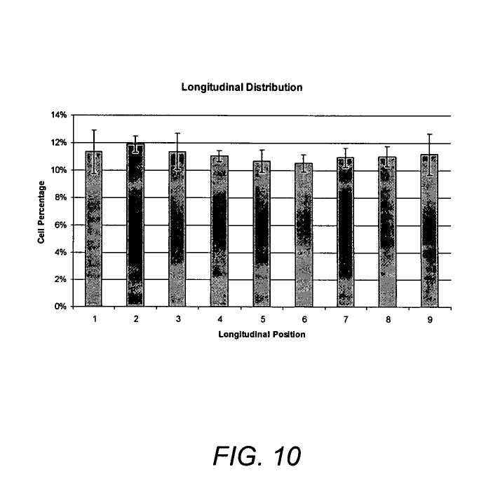

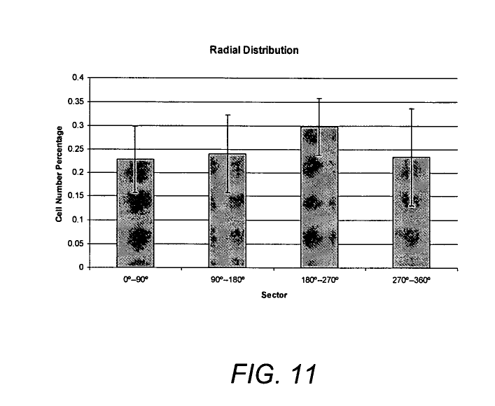

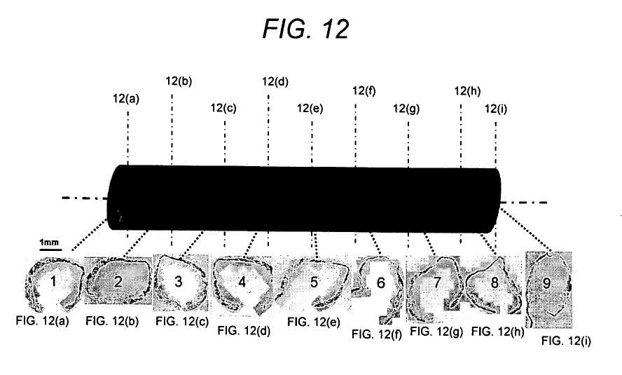

The first bulk seeding experiment showed a high level of longitudinal uniformity represented by the comparison of the normalized average cell number percentage for each of the nine longitudinal segments within each of the six seeded scaffolds. The Krustal Wallis test produced a p-value of 0.99 indicating no significant differences in the longitudinal distribution within each of the six scaffolds (FIG. 10). The reproducibility represented by the comparison of the cell number seeded in each location among six different scaffolds produced a p-value of 0.24 (FIG. 10). FIG. 10 illustrates the percentage of the total cell number seeded in each construct calculated summing the MTT absorbances for each of the six scaffolds. The second experiment showed non-significant differences among the total cell number in the four circumferential sectors along the seeded construct (p=0.25 FIGS. 11 and 12). FIGS. 12(a)-(i) illustrates the nuclear content in each of the nine longitudinal segments of the scaffold used for circumferential cell distribution assessment. (The image was inverted to represent the nuclei in black with a higher contrast.) The standard deviations observed in the circumferential cell distribution may be related to the heterogeneous thickness of the polymer around the circumferential dimension, as frequently observed in the microscope sections, allowing thicker sectors to bear more cells and thinner sectors to bear a lower amount of cells upon saturation of the available space. This dataset could not been normalized by thickness because the polymer was not visible in the microscope pictures taken under UV light. The observed variations in thickness are probably due to the manual nature of the polymer processing technique and should be dramatically reduced upon use of automated processes.

Endothelialization Experiments

The endothelialization capability of the device was tested with two experiments in which a small pore 2 cm long electrospun tubular construct was seeded with rBMPC or bAEC. The reduced pore size of the polymer prevented the passage of cells through the thickness of the tubular scaffold but did not prevent the passage of the liquid phase therethrough. The scaffolds were both seeded with 8 million cells suspended in 20 mL of culture media using the same seeding parameters used for the bulk seeding experiments; the duration of the seeding was one minute. A ring of the first construct was cut 1 hour after seeding, fixed, and stained with nuclear stain while the remainder of the first and second construct were kept for 12 hours in static culture conditions to allow the cells to spread on the surface. They were subsequently fixed and processed for electron microscopy.

The specimens were fixed in 4% paraformaldehyde for 1 hour and subsequently kept overnight in 30% sucrose solution. After PBS wash, the specimens were embedded in tissue freezing medium (TBS, Triangle Biomedical Sciences, Durham, N.C.) and sectioned with a Cryostat (Cryotome, ThermoShandon, Pittsburgh, Pa.). The sections prepared for cytoskeletal markers were permeabilized in Triton-X-100 solution (Fisher Scientific, Fair Lawn, N.J.) for 15 minutes and F-actin filaments were stained with 1:250 dilution of phalloidin conjugated to fluorescein-5-isothiocyanate (FITC) (Molecular Probes, Eugene, Oreg.) for an hour. The sections were counterstained with the nuclear stain DAPI (bisbenzimide, Sigma) for one minute. The sections were observed via epifluorescence microscopy using an Eclipse E800 (Nikon Instech Co., Ltd., Kanagawa, Japan) with UV filter for the DAPI stain and with FITC filter for the phalloidin stain.

Each specimen was placed in 200 μL of media supplemented with 20 μL of MTT solution [3-(4,5-dimethylthiazol-2-yl)-2,5-diphenyltetrazolium bromide] (Sigma) into a single well of a 96 multiwell plate immediately after culture. The specimens were kept for 4 hours at 37° C. Samples were then immersed in 2.5% isopropanol/HCl solution and kept for 24 hours at 4° C. The adsorbance was read at 570 nm with a microplate reader (model 680, Bio-Rad, Hercules, Calif.) and normalized to the dry weight of each ring and the total cell number in each construct. The cell number was obtained with a previously derived standard curve for the cell type of interest.

After 12 hours of static culture, the specimens were fixed in 2.5% glutaraldehyde for one hour, washed in PBS and re-fixed in 1% OsO₄ for another hour. After multiple washes in PBS the specimens were dehydrated with ethanol gradient (from 30% to 100%), and subsequently processed with critical point drying (Emscope CPD 750, Emscope Lab., Ashford, UK) with 4 cycles of liquid CO₂ soaking and venting at 10° C. before reaching the critical point for CO₂ at 31.1° C. at 1100 psi. After complete dehydration the specimens were gold sputter coated (Sputter Coater 108 auto, Cressington Scientific Instruments Inc., Cranberry Twp., Pa.) with a 3 nm thick layer of gold. The luminal surfaces in different location of the seeded scaffolds were observed with field emission scanning electron microscopy (JSM-6330F, JEOL ltd. Tokyo, Japan).

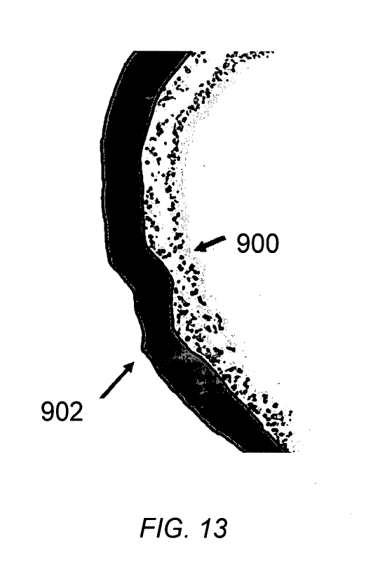

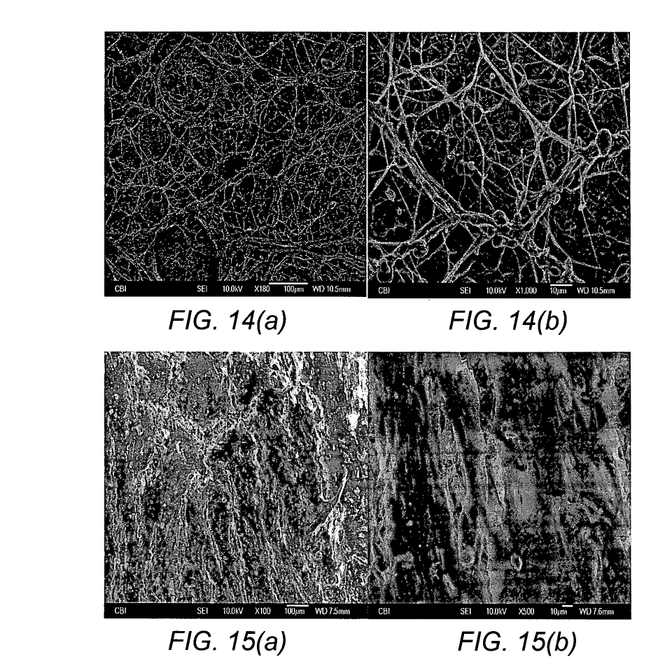

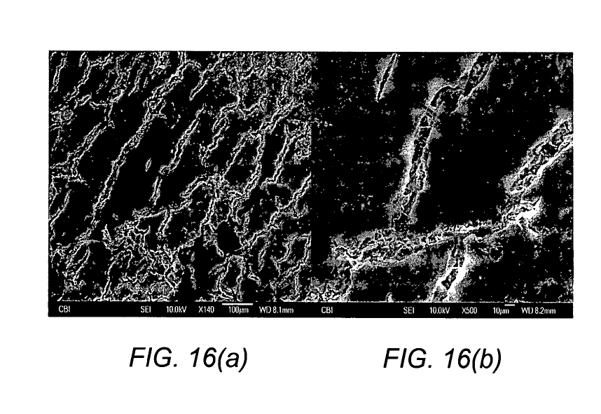

The construct seeded with BMPCs showed, immediately after seeding (1 hour), an accumulation and passive adhesion of all cellular components on the luminal surface 900, they were homogeneously distributed in both the circumferential and the longitudinal direction of the construct. FIG. 13 illustrates the accumulation of BMPCs (nuclei) in the luminar surface 900 of the electrospun PEUU scaffold 902 one hour after seeding procedure. The picture was inverted for increasing the contrast and modified for localizing the polymer which is invisible under UV light. The thickness is 15 μm and the magnification 200×. After 12 hours of culture, SEM showed a luminal surface completely lined with spread cells that formed a continuous layer upon the fibers of the electrospun polymer (FIGS. 15(a) and 15(b)). The construct seeded with bAECs showed a similar lining of ECs on the luminal surface of the construct (FIGS. 16(a) and 16(b)). A control polymer without seeding is illustrated in FIGS. 14(a) and 14(b).

Performance of the Device

The device was able to maintain a defined and constant level of vacuum over the operational cycle and to infuse a defined flow rate of seeding suspension across the porous matrix of the scaffold while rotating with a defined angular velocity. The permeability was 2.6·10⁻¹³ m² while the dynamic viscosity performed at 21° C. (consistent with the seeding temperature), was 1.03 cP. The CFD model simulation reached a prompt convergence with stability of the two surface monitors. The wall shear stress distribution on the luminal surface of the model was negligible (i.e. <1 dyne/cm²). According to the analytical expression used, the WSS in the representative smallest pore was 5.4 dyne/cm². It was observed that the seeding efficiency was dependent on the pore size of the polymer and on the flow rate used during the seeding procedure. In particular, it increased with smaller pores and lower flow rates, and it ranged from 65% to 90% in the tested scaffolds. The viability two hours after seeding was near 100% of the initial effective cell number incorporated into the scaffold according to the MTT assay and previously obtained calibration curve.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention. For example, it is understood that the invention has applicability in, e.g., vascular, urological, neurological, and musculo-skeletal contexts. In addition, the tubular shape of the scaffold used for the seeding does not limit the range of applicability since the cylindrical shape may be slit open in order to produce a flat sheet. Other shapes of scaffolding may also be employed, such as conical, toroidal, or prismatic shapes.

We claim:

1. An apparatus for seeding material in a porous scaffold member capable of entrapping seeding material therein, comprising:
a chamber having an interior and capable of maintaining a negative pressure and capable of enclosing a scaffold member therein; and
a support member for rotating the scaffold member disposed within the interior of the chamber and for introducing the seeding material into the chamber.

2. The device as recited in claim 1, wherein the support member comprises a hollow configuration.

3. The apparatus as recited in claim 2, wherein the scaffold member defines an interior portion and wherein the interior portion of the scaffold member is in communication with an interior portion of the support member, and wherein the seeding material is introduced into the interior of the scaffold member via the support member.

4. The apparatus as recited in claim 3, wherein the support member defines at least one aperture for introducing the seeding material into the interior of the scaffold member.

5. The apparatus as recited in claim 3, wherein the support member comprises a portion defining at least one aperture.

6. The apparatus as recited in claim 5, wherein the portion defining at least one aperture is adapted for movement within the interior of the scaffold member.

7. The apparatus as recited in claim 6, wherein the portion defining at least one aperture is adapted for axial movement within the interior of the scaffold member.

8. The apparatus as recited in claim 1, further comprising an expandable bag positioned within the support member.

9. The apparatus as recited in claim 1, wherein the scaffold member is rotated by mechanical attachment to the support member.

10. The apparatus as recited in claim 1, wherein the scaffold member is rotated by magnetic attachment to the support member.

11. The apparatus as recited in claim 1, wherein the chamber provides a pressure of about −20 to about −300 mm Hg.

12. The apparatus as recited in claim 1, wherein the chamber comprises acrylic.

13. The apparatus as recited in claim 1, further comprises a level controller for modulating the rotation speed of the support member.

14. The apparatus as recited in claim 1, further comprising a flow regulator for modulating the pressure level within the chamber.

15. The apparatus as recited in claim 1, further comprising a flow regulator for modulating the flow rate of seeding material into the chamber.

16. A method for seeding material in a scaffold member comprising:
applying a negative pressure condition to a scaffold member positioned within a chamber;
introducing seeding material in the scaffold member; and
rotating the scaffold member, wherein at least a portion of rotating the scaffold member occurs simultaneously with applying the negative pressure condition to the scaffold member.

17. The method of claim 16, wherein introducing seeding material in the scaffold member comprises introducing seeding material with a controlled flow rate.

18. The method of claim 16, wherein the scaffold member has a tubular structure defining an interior and wherein introducing seeding material in the scaffold member comprises introducing seeding material into the interior of the scaffold member via the support member.

19. The method of claim 18, wherein introducing seeding material in the scaffold member comprises passing at least a portion of the seeding material from the interior of the scaffold member to an exterior of the scaffold member.

20. The method of claim 19, wherein passing at least a portion of the seeding material from the interior of the scaffold member to an exterior of the scaffold member comprising passing at least a portion of the seeding material from the interior of the scaffold member to an exterior of the scaffold member in response to the negative pressure in the chamber and the flow of the seeding material.

21. The method of claim 18, wherein introducing seeding material in the scaffold member comprises introducing the seeding material into the interior of the scaffold member via at least one aperture in the support member.

22. The method of claim 21, wherein the support member comprises a portion defining at least one aperture, and wherein introducing seeding material in the scaffold member comprises moving the portion of the support member defining the aperture within the interior portion of the scaffold member.

23. The method of claim 22, wherein introducing seeding material in the scaffold member comprises axially moving the portion of the support member defining the aperture within the interior portion of the scaffold member.

24. The method of claim 16, wherein introducing seeding material in the scaffold member comprises entrapping at least a portion of the seeding material in the scaffold member.

25. The method of claim 24, wherein the scaffold member comprises an interior surface and wherein entrapping at least a portion of the seeding material in the scaffold member comprises entrapping the seeding material adjacent the interior surface of the scaffold member.

26. The method of claim 24, wherein the scaffold member defines a thickness and wherein entrapping at least a portion of the seeding material in the scaffold member comprises entrapping the seeding material throughout the thickness of the scaffold member.

27. The method of claim 16, further comprising modulating the pressure within the chamber.

28. The method of claim 16, further comprising modulating the rotational speed of the support member.

29. The method of claim 16, further comprising modulating the flow rate of the seeding material.
